(19) United States
(12) Patent Application Publication
(10) Pub. No.: US 2020/0189223 A1
(43) Pub. Date: Jun. 18, 2020

(54) DEVICE AND METHOD FOR COMPACTING HOLLOW ELEMENTS BY CRUSHING

(71) Applicant: Hermann Schwelling, Salem (DE)

(72) Inventor: Hermann Schwelling, Salem (DE)

(21) Appl. No.: 16/304,954

(22) PCT Filed: Mar. 13, 2018
(86) PCT No.: PCT/EP2018/056239

§ 371 Date: Dec. 10, 2018

(30) Foreign Application Priority Data
Mar. 15, 2017 (DE) 102017105526.6

(51) Int. Cl. B30B 9/32

(52) U.S. Cl. CPC B30B 9/325

(57) ABSTRACT

According to the invention hollow elements 100.1 like bottles (100.1a) or cans (100.1b) are not only flattened for stronger compacting and thus optionally also perforated but the generated flattened plate-shaped hollow element (100.2) is crushed additional which increases the thickness of the plate by a small amount but which further reduces overall volume. The crushing is advantageously performed by reduced speed passage through a second roller pair, the crushing roller pair (3a, b) compared to a speed of running through the pressing roller pair (1a, b).

### I. FIELD OF THE INVENTION

The invention relates to hollow elements like, e.g., plastic bottles or metal cans. These are returned by customers and the customer is typically refunded a deposit and the hollow elements are typically still compacted at the return location in order to reduce the transport volume for transporting to a recycling plant.

Different methods are known.

One method includes shredding the container into small particles which can then be processed into bulk material. Another method includes crushing the containers typically into plate-shaped flattened items that are zeroed out with respect to their refund claim. This has the advantage that such flattened containers can also be compressed into bales and strapped bales can be transported without additional envelopment which is not possible for shredded hollow elements.

The instant invention relates to the second method of compressing the containers.

### II. BACKGROUND OF THE INVENTION

Typically the containers are crushed by running them between two pressing and cutting rollers that mesh with each other which does not only press the two opposite walls of the container against each other but cuts the walls by the cutting teeth of these pressing and cutting rollers in sections so that the two adjacent walls of the compressed container hook into each other, and a subsequent spring back of the compressed container from the plate shape into a thicker shape caused by intrinsic elasticity of the material of the container is prevented.

The cutting also facilitates to let air escape from a container that is typically closed by a closing cap during crushing and to let residual fluid exit from the container.

However, a density of a transport unit of flattened containers is lower than a density of a transport unit of shredded containers though this also depends on shape and size of particles produced during the shredding.

### III. BRIEF SUMMARY OF THE INVENTION

### a) Technical Object

Thus it is an object of the invention to provide a method and a device for stronger compacting of entire hollow elements without shredding them into particles.

### b) Solution

The object is achieved by the features of claims 1 and 22. Advantageous embodiments can be derived from the dependent claims.

With respect to the compacting method the respective hollow element is flattened, in particular by force loading transversal to its largest extension. This yields an approximately plate-shaped, two-layer hollow element at least in a central portion, wherein the two layers are formed by opposite sections of the wall of the hollow element. The two layers are connected with each other at the outer portions circumferentially by the material of the wall and possibly by a closure as long as the hollow element does not burst during flattening.

The latter shall be prevented in that the flattening perforates at least one layer of the eventually plate-shaped hollow element or cuts it by short cuts.

Depending on the device used the two layers can contact each other at least in portions, however, typically not over the entire surface of the plate, thus of the plate-shaped hollow element due to the spring back properties of the material.

During perforating or cutting both layers of the plate-shaped hollow element are partially cut by the same tool at the same location in particular in order to achieve a hooking of the cutting edges of the two layers at each other and to minimize spring back.

The cutting, however, is only performed partially, and a cutting of the hollow elements into individual pieces or small particles shall not be performed.

Advantageously the flattening is done in a flow-through process while the plate-shaped hollow elements are subsequently moved in flow-through direction. The extension of the main plane of the plate-shaped hollow element transversal to the flow-through direction and the flow through direction itself define a flow-through plane.

According to this known method step, the approximately plate-shaped hollow element, thus the double layer plate, is crushed in one of the directions of the main plane of this plate, thus pushed together so that the plate becomes shorter in this direction and thus also thicker. Namely the crushing produces an accordion-shaped crushed hollow element where each of the walls cut along the crushing direction has a wave-shaped or zig-zag shaped profile.

Thus, it is advantageous when the crushed hollow element is subsequently compressed again transversal to its crushing direction in order to further reduce the volume.

Advantageously lateral supports which extend approximately in crushing direction and which define a support slot prevent a lateral escaping thus bulging of the accordion-shaped hollow element.

Advantageously the crushing is performed with a crushing direction along a largest extension of the flattened hollow element which advantageously coincides with a largest extension of the original non-deformed hollow element. When flattening in a pass-through process the compression direction is identical with the flow-through direction during flattening or oriented against the flow-through direction.

The crushing is advantageously terminated before stress whitening occurs at the folds of the accordion when the hollow element is made from a plastic material since this degrades the value of the crushed hollow element.

Advantageously crushing the plate-shaped hollow element is already commenced before the prior flattening of the hollow element is completed. This facilitates the transition from the first to the second operating step in particular when flattening and/or crushing is performed by a flow-through process and reduces the risk of lateral escapement.

Advantageously the crushing of the plate-shaped hollow element is terminated at the latest when the flattening of the hollow element is terminated, in particular when the crushing of the hollow element is used as a reaction bearing and stop during crushing.

Advantageously the flattening of the hollow element is performed by driving the hollow element through a compression slot between at least one compression roller that is driven to rotate and an opposite compression element which may be a compression slide surface or a second compression roller that rotates counteracting, wherein the compression slot advantageously contracts in extension direction, in particular down to a thickness which corresponds approximately to a plate-shaped hollow element generated.

Advantageously when there are two cooperating compression rollers the teeth of the first compression roller which are offset in an axial direction mesh with teeth of the other compression roller in that they penetrate between their teeth in the axial direction which produces a wave-shaped, flattened hollow element.

Accordingly the pressing slot in this context does not mean necessarily that a free passage and clear view is provided in an axis direction of the at least one pressing roller between the at least one pressing roller and the opposite pressing element, e.g., the second pressing roller.

Namely due to the alternating penetration of the teeth of the first pressing roller into circumferential grooves between the teeth of the other pressing roller, the pressing slot, viewed along a plane defined by the two rotation axes of the pressing rollers meshing with each other, is, on the one hand side, provided with multiple elbows and additionally interrupted in the axial direction typically also at several locations, namely where adjacent teeth of the two compression rollers are arranged, contacting each other closely in the axial direction in order to cause a cutting and penetration of at least one of the two walls of the hollow elements to be flattened, wherein the two walls are closely adjacent to each other in this location.

Thus, the hollow element to be processed is fed to the compression slot advantageously in one direction which corresponds to the greatest longitudinal extension of the hollow element so that the compression rollers only have to have a rather short axial length.

The hollow element is gripped by advantageously hook-shaped teeth that radially protrude from at least one of the compression rollers and pulled into the compression slot, wherein wipers that are advantageously arranged at an outlet of the compression slot between the teeth prevent that the teeth pull a gripped wall of the hollow element along in a circumferential direction after an end of the compression slot.

Advantageously the hollow element is pressed into the compression slot by a feed device that is arranged upstream of the compression slot in flow through direction in order to facilitate and reliably perform the capturing of the hollow element by the at least one, advantageously two pressing rollers.

The flat pressing, however, can be performed by two press plungers that are movable relative to each other wherein the hollow element is positioned between the press plungers and which can compress the hollow element wherein a surface of the press plungers is advantageously selected large enough so that the entire hollow element fits between the two press plungers and does not protrude laterally beyond the two press plungers.

When the hollow element is run through a compression slot in order to be pressed flat the crushing can be performed by braking a front end in pass through direction of the flattened hollow element so that the front end of the flattened hollow element moves forward more slowly than the rear end and the front end of the flattened hollow body can even come to a standstill downstream of the pressing slot before flat pressing in the pressing slot is completed.

The braking of the front end in pass through direction of the plate shaped hollow element can be performed by contacting a stop as a crushing element wherein the stop can be configured fixed or move able in the pass through direction. The braking can also be implemented in that the plate shaped hollow element is run through a crushing slot downstream of the pressing slot wherein a pass through velocity through the crushing slot is less than a pass through velocity through the pressing slot.

As long as the same plate shaped hollow element is already in the crushing slot with its front portion and contacts the crushing element and is still in the pressing slot with its rear portion a crushing of the plate shaped hollow element is performed wherein a slippage between the plate shaped hollow body and the crushing element shall not occur if possible.

Thus a pass through velocity through the crushing slot is less than half, advantageously less than a third of the pass through velocity of the same hollow element through the compression slot.

In order to prevent slippage a width of the crushing slot in at least one direction is smaller than a flattened hollow element to be run through advantageously in a transversal direction to the main plane of the flattened hollow element smaller than its thickness.

Thus, the hollow element that is already flattened and crushed in the pass through direction is compressed again transversal to the pass through direction in particular transversal to the main plane of the still plate shaped hollow element that is already crushed in one of the main planes of the plate which provides further compacting.

Thus, the defining surfaces of the crushing slot represent the crushing element either by correspondingly high dynamic friction for a smooth defining surface of the crushing slot that extends in the pass through direction or through form locking if the defining surface is at least partially oriented transversal to the pass through direction through the crushing slot.

For the purposes of the instant invention it shall be clarified that a transversal direction without further reference with respect to the hollow element for a hollow element that is not deformed yet is an orthogonal to its largest extension or thereafter the orthogonal to the main plane of the flattened plate shaped hollow element. With respect to the device the transversal direction is the direction which is on the one hand side orthogonal to the pass through direction and on the other hand side orthogonal to the axial direction of the rollers.

Moving through the compression slot is advantageously caused in that the flattened hollow element is captured by at least one crushing roller that laterally defines the crushing slot and which is advantageously driven to rotate and wherein the hollow element is pulled through the crushing slot so that the circumferential surface of the at least one crushing roller is a defining surface of the crushing slot.

Advantageously two crushing rollers that are arranged adjacent to each other are driven to rotate counter acting wherein the crushing rollers are arranged close enough together so that they contact a plate shaped hollow element inserted there between with a friction force that is large enough so that the hollow element is pushed through the crushing slot, but not with a pass through speed that is greater than a circumferential velocity of the one or the two crushing rollers since no slippage or only a very small slippage shall occur between the plate shaped hollow element and the two crushing rollers.

In order to achieve a sufficiently high friction relative to the plate shaped hollow body the at least one crushing roller, advantageously both crushing rollers can be covered with teeth between which the plate shaped hollow element has to pass through so that the surface of the teeth also becomes part of the defining surface of the crushing slot, wherein the teeth are partially transversal to the pass through direction and thus prevent a relative movement between the flattened hollow element and the crushing element configured as the crushing roller through form locking. The teeth of the two crushing rollers can overlap in the radial direction and can mesh with each other like gears touch free and/or can be offset relative to one another in the axial direction and can engage each other in an alternating manner in the axial direction.

Advantageously the crushing slot viewed in the axial direction as well as in the pass through direction is formed by a continuously provided offset between the 2 crushing rollers.

In particular a circumferential velocity of the at least one crushing roller during operations of the device is less than half, advantageously less than ⅓ of the circumferential velocity of the at least one pressing roller.

A pressing of the hollow element to be processed into the pressing slot can be performed by a feed device in particular the blades of a blade shaft whose rotation axis is approximately parallel to the rotation axes of the at least one pressing roller if such pressing roller is provided.

The blade that comes into contact with the hollow element moves with its free end in a direction towards the press slot or the press station wherein however the free end of the blade has a circumferential velocity which is significantly larger than a circumferential velocity of the at least one press roller when the flattening is performed by a press roller.

Thus, the object is achieved with respect to the compacting device in that a pressing device for flattening the hollow elements according to the invention includes an additional downstream crushing device in order to crush the approximately plate shaped hollow element that was flattened in the pressing device in one of the directions of the main plane of the plate.

The pressing device and the crushing device are thus offset from each other so that they can simultaneously impact the same hollow element that is to be processed, thus the crushing device impacts more in a front portion of the hollow element and the pressing device than impacts in its rear portion.

The device is advantageously not manually operated but includes a drive device which drives the pressing device and/or the crushing device and/or the feed device in particular the blade shaft and advantageously also a control for controlling at least all move able portions of the device and in particular of the drive device. The control can be in particular part of a control of a super ordinate unit in which the compacting device is installed e.g. of a bottle return machine.

Advantageously only one motor drives the pressing device as well as the crushing device and optionally also the feed device.

Advantageously the pressing device includes at least one pressing roller that is drive able to rotate, whose function consists of gripping the hollow element and pulling it through a pressing slot that is formed between the pressing roller and an opposite pressing element which reduces a thickness of the hollow element and flattens the hollow element.

The flow through direction on the one hand side and the axial direction of the at least one pressing roller on the other hand side define the pass through plane.

For this purpose a width of the pressing slot is certainly much less than a width of the non-deformed hollow element and has a thickness approximately corresponding to a desired thickness of the plate shaped hollow element to be thus produced.

The opposite pressing element can be in a simple case a particularly fixed press support surface that extends in the flow through direction and that is arranged approximately parallel to an outer circumference of the pressing roller. However a second rotate able pressing roller that is in particular also drive able to rotate in an opposite direction to the first pressing roller and in particular meshing with the first pressing roller has proven to work better as an opposite pressing element.

In order to capture and perforate the hollow element the at least one pressing roller, advantageously both pressing rollers have teeth that are distributed and offset over a circumference and/or in an axial direction which are advantageously configured hook shaped and with a sharp cutting edge in order to be able to easily capture the hollow element and pull it into the pressing slot and to additionally penetrate the wall of the hollow element and to let included air and liquids escape.

The teeth are advantageously arranged axially offset in tooth ring portions which are sized so that the tooth ring portions of one pressing roller can radially penetrate between the tooth ring portions of the adjacent pressing roller, wherein a free space is provided between the roller, thus in the radial direction as well as also in the axial direction between the teeth and the tooth ring portions wherein the free space suffices to run the hollow element through there between while still flattening the hollow element.

The pressing slot has a uniform width in the axial direction, advantageously over its entire length in the axial direction, which means that a widest spot is at the most 20% wider, better at the most 10% wider, better at the most 5% wider than the narrowest spot.

The rotation axes of the pressing rollers are advantageously arranged parallel to each other but can also be arranged at an angle relative to each other when the pressing rollers are configured for example conical.

These features of a pressing device are essentially known in the art.

The crushing device that is arranged downstream in the flow through direction can include a stop in a very simple embodiment that is arranged in a movement path of a plate shaped hollow element that comes out of the pressing slot wherein the plate shaped hollow element presses against the stop with a front end and wherein a supply of plate material from the pressing slot of the plate shaped hollow element is crushed against the flow through direction which generates an approximately accordion shaped crushed hollow element.

The stop can thus be arranged stationary or it can move together in pass through direction with the plate shaped hollow element pressing against the stop, however the stop moves at a lower speed than the flow through speed of the same hollow element through the pressing slot.

The stop can also be moved out of the movement path of the plate shaped and thus subsequently crushed hollow element in order to complete the crushing process in order to facilitate an extraction of the hollow element.

The stop can also be force loaded against the pass through direction for this purpose, e.g., by a spring or a break device in order to define the crushing force.

The advantageous embodiment of the crushing device according to the invention, however, includes at least one first crushing roller which is driven to rotate, wherein the first crushing roller is used for capturing the flattened hollow element and pulling it through a crushing slot, however with a slower pass-through speed than the pass-through speed of the same object through the pressing slot that is further upstream wherein the rear portion of the plate shaped hollow element is still in the pressing slot whereas the front portion is already moved through the crushing slot.

Advantageously the crushing device does not only include a crush support surface as an opposite crushing element which extends in the pass through direction and parallel to the first crushing roller, but also a second crushing roller that rotates counter acting to the first crushing roller wherein the second crushing roller is also in contact with the hollow element that is run through the crushing rollers and already plate-shaped and crushed, which avoids a sliding friction relative to a fixed support surface.

The axis orientation of the crushing rollers can thus be parallel to the orientations of the pressing roller or viewed in pass through direction at an angle without intersecting, in particular at a right angle.

Due to the reduced pass through speed in the crushing device the plate-shaped hollow element is jammed upstream of the crushing device by the feeding of the plate-shaped hollow element from the pressing slot with significantly higher speed so that the actual crushing process is performed in the portion between the pressing device and the crushing device wherein crushing rollers perform the stop and braking function, thus they are used as crushing elements.

Since the plate-shaped hollow element arrives at the crushing slot already in a crushed condition, thus in a thickened accordion shaped condition compared to the plate shaped condition, the crushing slot has at least the same width as the pressing slot transversal to the pass-through plane, advantageously it is sized wider than the pressing slot, advantageously however at least twice as wide at the most three times as wide.

Namely in the crushing slot the already flattened and crushed hollow element shall be compressed again in the transversal direction to the flow through direction by crushing rollers in order to further reduce a volume of the hollow element.

Thus, the crushing slot is positioned in the flow through direction so that a flattened hollow element coming out of the pressing device has to protrude in the crushing slot thus before it has completely left the pressing device and before it is captured by the at least rotating crushing roller or the crushing roller pair and is thus moved slower through the crushing roller pair and the crushing slot.

Like for the pressing rollers the crushing slot of the crushing rollers should have identical width in the axial direction of the rollers. Everywhere, thus the widest spot should not be wider than 20% at the most, better 10% at the most, and even better 5% at the most than the narrowest spot. Advantageously the rotation axes of the pressing rollers are also parallel to one another and/or parallel to the rotation axes of crushing rollers.

The rollers, advantageously the pressing rollers as well as the crushing rollers have a respective bearing journal at their axial ends and the typically teeth bearing operating portion arranged there between can be used to impact the hollow element. More precisely the operating portion is an axial portion of the rollers which can come into contact with the hollow elements, in particular a portion between the defining plates on both sides wherein the pressing rollers are arranged opposite thereto. Advantageously an operating portion is shorter in the axial direction than a largest extension of the smallest hollow element that is to be processed.

This has the effect that the hollow elements can only be fed to the entire device in a direction of their largest extension.

The volume flow through is thus reduced compared to a feed in the transversal direction of the hollow element, however, a plate-shaped flattened hollow element that is as long as possible in the pass-through direction is advantageous for the subsequent crushing since this facilitates that its front portion is already gripped by the crushing device before its rear portion has exited the pressing device.

Accordingly also the distance between the pressing device and the crushing device in the flow through direction, the so-called pass-through distance has to be selected as a function of dimensions of the hollow elements that are scheduled for processing and the distance can be in particular adjustable, in particular also during operations of the device in particular the pass-through distance is the distance respectively between the narrowest spots of the pressing slot and on the other hand side of the crushing slot.

In order to be able to still crush the shortest hollow element that is scheduled for processing. This flow-through distance has to be smaller than a length of the shortest hollow element that is scheduled for processing wherein the length is measured in the pass through direction, in particular the pass-through distance has to be shorter than a largest extension of the hollow element or its greatest extension in the flattened plate-shaped condition.

Typically the device shall be capable to process a particular size spectrum of hollow elements and the pass-through distance, and partially also the diameters of the crushing rollers and/or of the pressing roller are fixated and selected so that all hollow elements within this size range can be processed therewith.

However, since the compression occurring in a long, flattened hollow element is stronger than in a flattened hollow element that is short in the pass-through direction, the pass-through distance must not be selected too short since, in particular for a hollow element that is very long in pass-through direction, the crushing in particular for a hollow element made from plastic could become strong enough so that stress whitening can occur at the bends of the accordion-shaped crushed hollow element and even more so at the bends of the crushed, and subsequently transversally compressed hollow element if this hollow element is made from synthetic material, wherein a value of the crushed hollow element would be reduced.

In practical applications the pass through distance is advantageously selected so that the shortest hollow body in pass through direction that is scheduled for processing is sufficiently crushed but no stress whitening occurs at the longest possible container. Also the width of the crushing slot will be adjusted this way.

If the pass-through distance is adjustable, the pass-through distance is advantageously automatically adjusted as a function of a length of the hollow element in the pass-through direction that is detected as a function of the feed to the device, thus the pass-through direction is selected the shorter, the fed hollow element in the pass-through direction.

Like for the at least one press roller, a layer with radially protruding teeth is also provided on the at least one crushing roller wherein the teeth are advantageously arranged distributed over the circumference and/or advantageously arranged in axially offset tooth-ring portions.

Contrary to the pressing rollers, the teeth or tooth ring portions do not have to engage each other in the radial direction when two crushing rollers are provided, also in view of the fact that the hollow element arriving at the crushing rollers is already crushed and thus thickened compared to the flattened condition at the runout of the pressing device, however, this engagement assures particularly effectively that there is no slippage between the hollow element and the crushing rollers in the crushing slot.

The thickening can only be reduced within limits by the crushing device, in particular the crushing device and in particular the at least one crushing roller, thus in the crushing slot since an excessive compression transversal to a main plane of the thicker but in principle still plate-shaped crushed hollow element would lead to an undesirable lengthening of the crushed hollow element in the pass-through direction.

A width of the crushing slot is therefore selected so that the crushed plate-shaped hollow element that is run through can be captured easily by typically two provided crushing rollers, but the hollow element cannot be pressed through the crushing slot any quicker than corresponding to the circumferential speed of the at least one crushing roller.

A tooth shape of the at least one crushing roller typically differs from a tooth shape of the at least one pressing roller.

Since a thickness reduction in the crushing slot is typically less than in the pressing slot, capturing and pulling in through the teeth of the at least one crushing roller is without problems since the fed hollow body is fed to the crushing slot with substantial force in the pass-through direction and presses against the teeth of the crushing rollers. Thus the teeth of the crushing roller shall have a sufficiently high static friction primarily between the teeth of the crushing rollers and the accordion-shaped hollow body that is transported through wherein the static friction is caused by a corresponding distortion of the hollow body that is passed through.

The teeth of the pressing roller are advantageously configured hook-shaped for capturing and also cutting, thus perforating the wall of the hollow body. Therefore, the front surface oriented in the rotation direction of the pressing roller is oriented radially relative to the axial direction, or its free outer end is oriented further forward relative to the inner end in rotation direction so that the hook shape is generated.

Since this is not necessary for the crushing roller, the front flank can also be configured receding in the rotation direction, thus the free outer end of the front flank of the tooth can be further behind in the rotation direction than the radial inner end.

Since no cutting function has to be performed by the teeth of the crushing roller, no sharp edge is provided at the relevant locations of the crushing roller, but a convex or concave camber or slant is provided.

In the teeth of the crushing roller this relates to their outer edges, thus either the circumferential edges and/or also the outer end edges extending transversal to the rotation direction wherein the outer end edges can then have a convex camber or a slant.

The grooves between two axially sequential teeth can have a concave camber or bevel at a transition from their base to their flanks.

When the teeth do not protrude from a typically cylindrical base element of the roller, in particular the crushing roller, but an additional circumferential groove is configured in the base element between the corresponding tooth ring portions, this also applies for the outer edges of the circumferential grooves extending in the circumferential direction, so that the outer edges can also have a convex camber or slant and/or the transition from the base to the flanks which can have a concave camber or bevel.

This is used on the one hand side to avoid an occurrence of stress fracture in the synthetic material during crushing as far as possible and on the other hand side so that no circumferentially closed channels are formed on an outside of the container during crushing and optionally subsequent compression, but only outward open recesses, so that all surface portions are accessible during subsequent remaining of the label residuals from the surface of the container, in particular for removing label residuals through rinsing and subsequent blow drying or blowing off the label residuals.

Besides that, a sufficient clear space for passing the hollow element through should also be provided for cooperating rollers that are covered with teeth that mesh with each other wherein an axis offset of the rollers is less than a sum of their greatest radii, thus in a radial direction and also in an axial direction between the cooperating rollers and their parts.

From the known pressing devices that include a pair of pressing and cutting rollers, plate-shaped or finger-shaped wipers are known in principle wherein the wipers are permanently mounted in pass-through direction downstream from the pressing rollers and reach radially into the axial distances, in particular the circumferential grooves between the tooth ring portions and reach as far down into the groove base as possible.

This prevents that the material of the hollow body interlocks with a tooth strongly enough so that the tooth does not release the wall material at an end of the pressing slot but carries it along in the circumferential direction and thus widens the flattened hollow element in an undesirable manner.

The wiper surface that is oriented towards the pressing slot, thus for plate-shaped wipers their narrow side represent an extension and thus delimitation of the pressing slot as a support slot and limit the thickening of the plate-shaped hollow element in this pass-through area through the already occurring compression.

In the device according to the invention with a subsequent downstream crushing device, in particular a crushing roller pair, the wipers are advantageously extended in a direction of the crushing device and can even penetrate into intermediary spaces between the tooth ring portions of the at least crushing roller.

This requires viewed transversal to the pass-through direction that the distances between the tooth ring portions of the at least one pressing roller are aligned with the tooth ring portions of the at least one crushing roller and advantageously have approximately the same width.

Advantageously this also applies for the respective tooth ring portions and their extension and positioning in the axial direction.

Thus the wiper surfaces viewed in the axial direction of the rollers limit a thickness of the crushing portion between the pressing device and the crushing device to a size by which the hollow element that is flattened in the pressing device can be widened through the crushing process transversal to the pass-through plane viewed in the axial direction of the rollers.

This delimitation by the wiper surfaces also presents that the entire accordion-shaped hollow element formed there between can escape laterally so that the crushed, accordion-shaped plate essentially remains a flat plate.

Advantageously a width of the support slot defined by the wiper surfaces increases between the pressing device and the crushing device in a direction towards the crushing device viewed in an axial direction of the rollers.

Advantageously the wiper surfaces terminate in the pass-through direction before the outer circumference of the crushing rollers so that the plate shaped hollow element can expand due to the crushing in a rather unlimited manner transversal to the pass-through plane in the gap between the crushing rollers that is measured in the pass-through direction otherwise if the crushing slot is limited on all sides high forces can be generated through the backed up material of the hollow element which can also lock or damage the device.

As it is known from generic pressing devices including a pair of pressing and cutting rollers a feed device can be arranged upstream of the pressing device wherein the feed device individualizes the incoming hollow elements and presses them into the pressing slot.

For this purpose a blade shaft is known which rotates about a rotation axis that is parallel to the rotation axes of the pressing device and from which blades extend in a radial direction which come in contact with a fed hollow element which advantageously slides on a slanted downward oriented feed sliding surface towards the pressing slot and press the fed hollow element towards the pressing slot.

In the instant application the blade shaft advantageously has two blades that are arranged opposite to each other and thus protrude radially in diametrically opposed directions.

The blades advantageously have free outer ends that are swept back in rotation direction thus which are further backward in the rotation direction than its inner ends proximal to the rotation axes.

Thus a blade shaft of this type typically has a greater circumferential velocity than a circumferential velocity of the at least one pressing roller in the pressing device. This has the additional effect that the blades of the blade shaft already compress the hollow element slightly when they slide along the hollow element which facilitates gripping and flattening in the subsequent pressing device.

Thus, a distance of the at least one blade shaft which forms a feed slot with the recited feed slide surface is selected so that the front end of the fed hollow element is already gripped by the pressing and typically also cutting rollers of the pressing device while the rear portion of the hollow element is still gripped by the blades of the blade shaft and moved forward.

In a radial direction the smallest distance between the free end of a blade and the blade counter element, in particular the feed slide surface is smaller than a thickness of the thinnest hollow element that is provided for processing so that the blades can still come in contact with a hollow element of this type.

The greatest possible distance between the blade shaft, in particular its central body at which the two blades are attached and the blade counter element, in particular the feed slide surface, however, is greater than a thickness of the thickest hollow element provided for processing since a thickest hollow element of this type could otherwise not be inserted into the feed slot anymore.

Advantageously the blades are configured viewed in axial direction arc-shaped or shaped as a part of a polygon with an end that is swept back in the rotation direction.

The blades of the blade shaft extend in particular in the axial direction over an entire length of the operating portion of the at least one pressing roller and are advantageously configured serrated at their free end edge.

Advantageously the blades have a bending stiffness that decreases towards the free end in the embodiment according to the invention so that the blades are advantageously configured slightly elastic at their free ends.

This can be provided in a simple manner also for blades which are made from a sheet metal that has constant thickness viewed in axial direction along their entire radial extension in that the blade is supported in a center portion on its back side with respect to the rotation direction. This can be performed in a simple manner by the rear free end edge of the other blade that contacts the back side wherein the rear free end edge extends past the rotation axis of the blade shaft to the back side of the other blade.

Through this specific configuration of the feed device the hollow element that are fed in this case in their longitudinal direction can be flattened by the pressing device to a large extent also for a rather large thickness and thus typically also length of the hollow element which improves the function of the subsequent crushing device and increases the crushing effect occurring then as described supra.

Thus, a strong crushing and therefore volume reduction can be achieved for rather large and thus long hollow elements.

### c) Embodiments

Embodiments of the invention are subsequently described in more detail with respect drawing figures, wherein

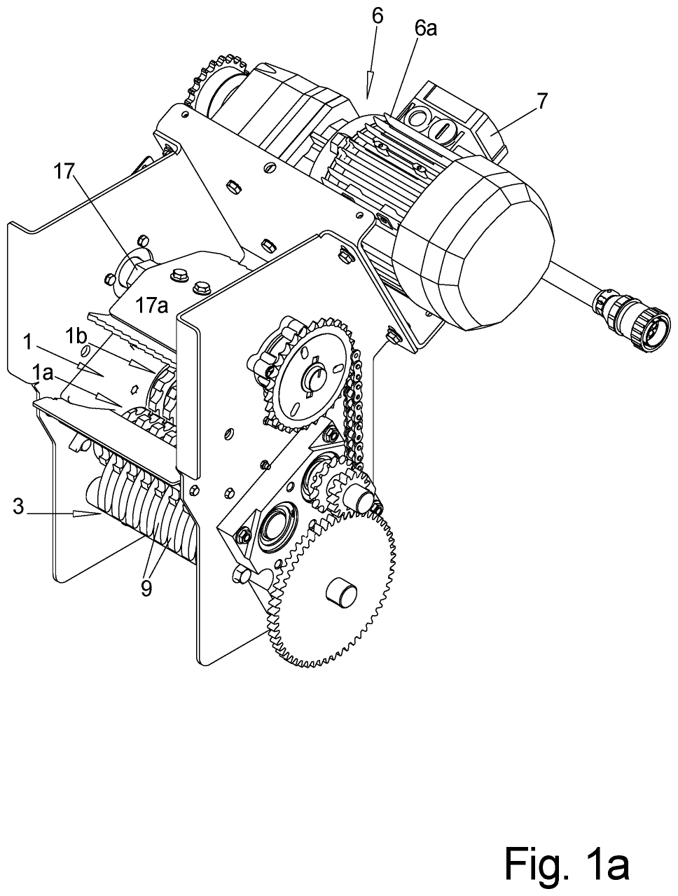

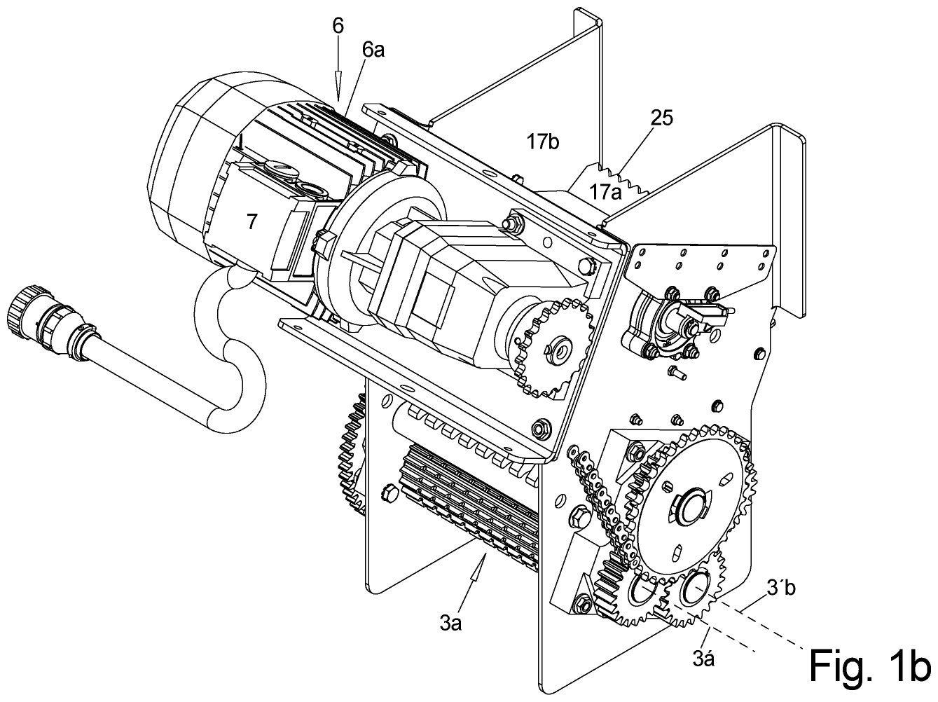

FIGS. 1a, b illustrate different perspective views of the first embodiment of the compacting device;

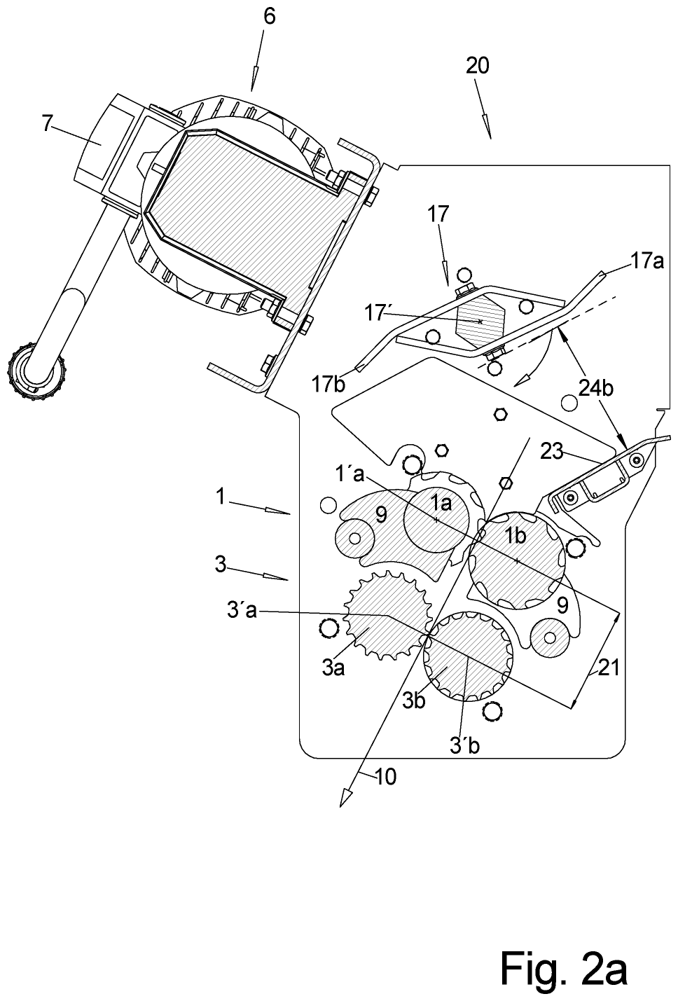

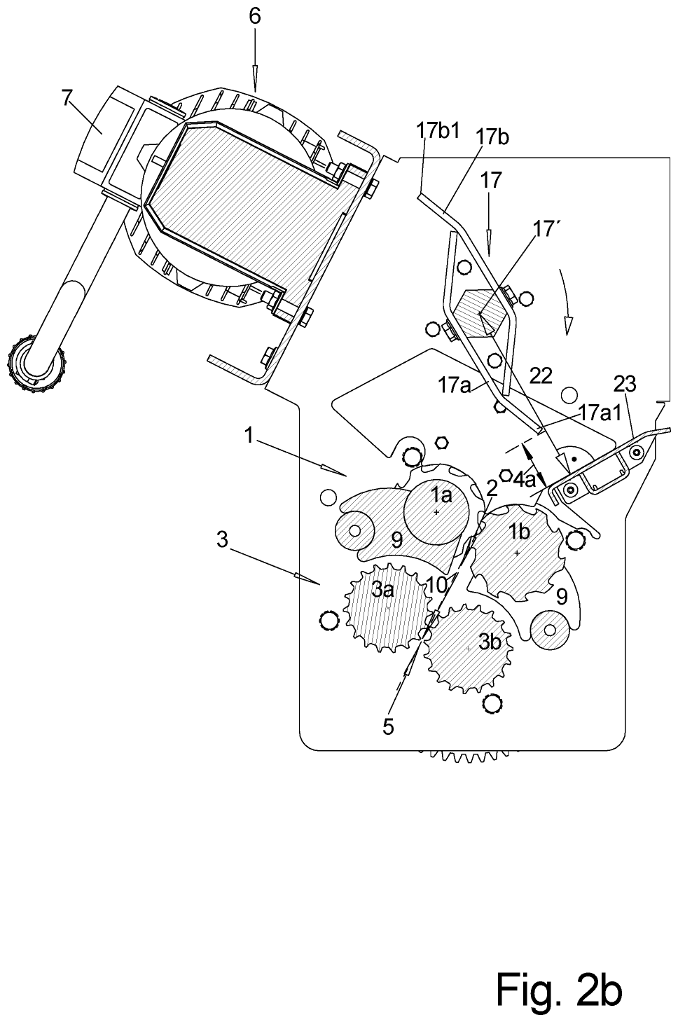

FIG. 2a, b illustrate sectional views through the compacting device of FIGS. 1a, b cut perpendicular to the axis direction of the rollers included therein;

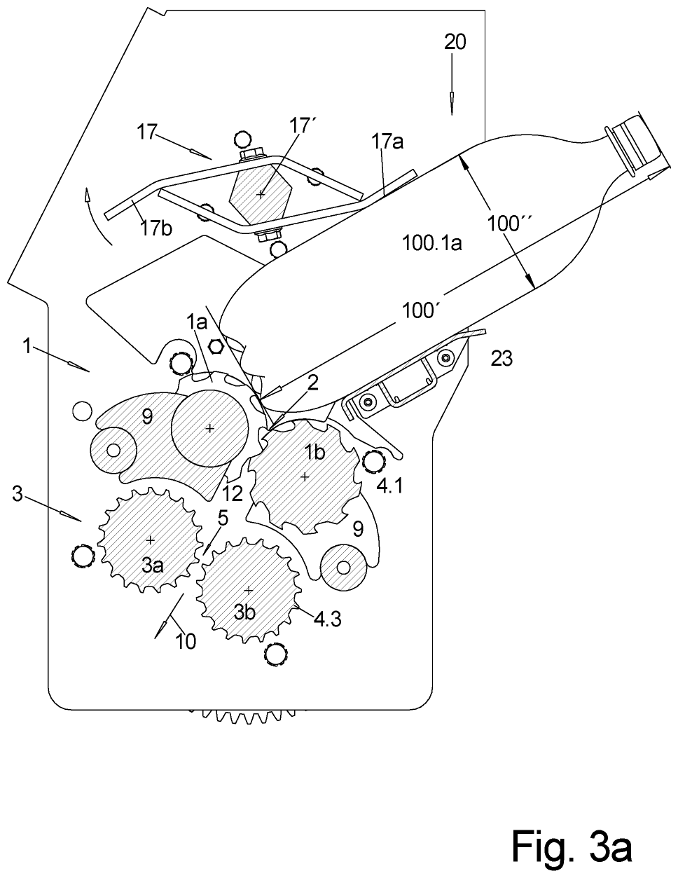

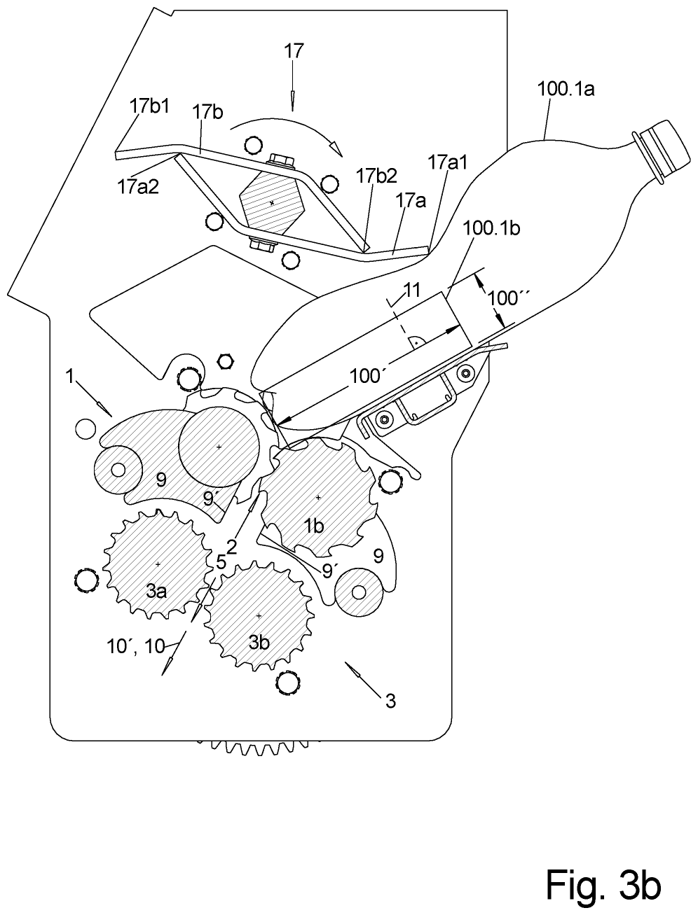

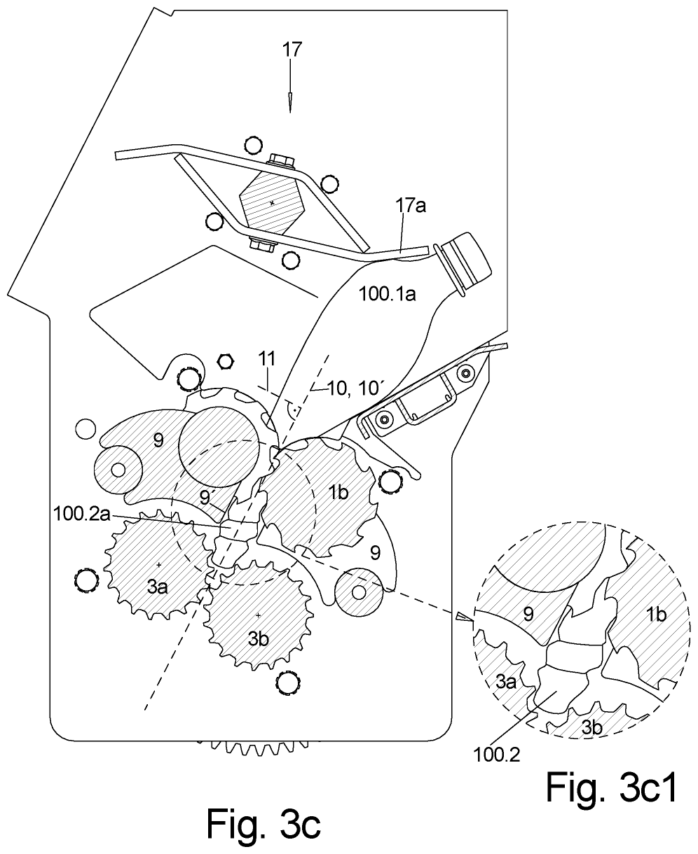

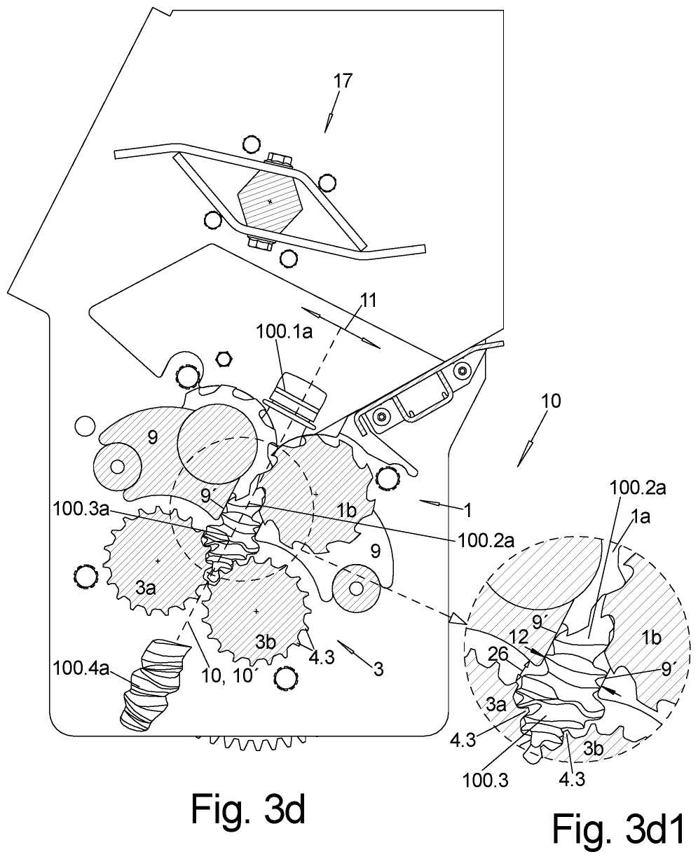

FIGS. 3a-d illustrate blown-up details in a view that is analogous to FIG. 2 in different operating conditions when processing a hollow element;

FIG. 3b1 illustrates a blown-up detail of FIG. 3b;

FIG. 3d1 illustrates an enlarged detail of FIG. 3d.

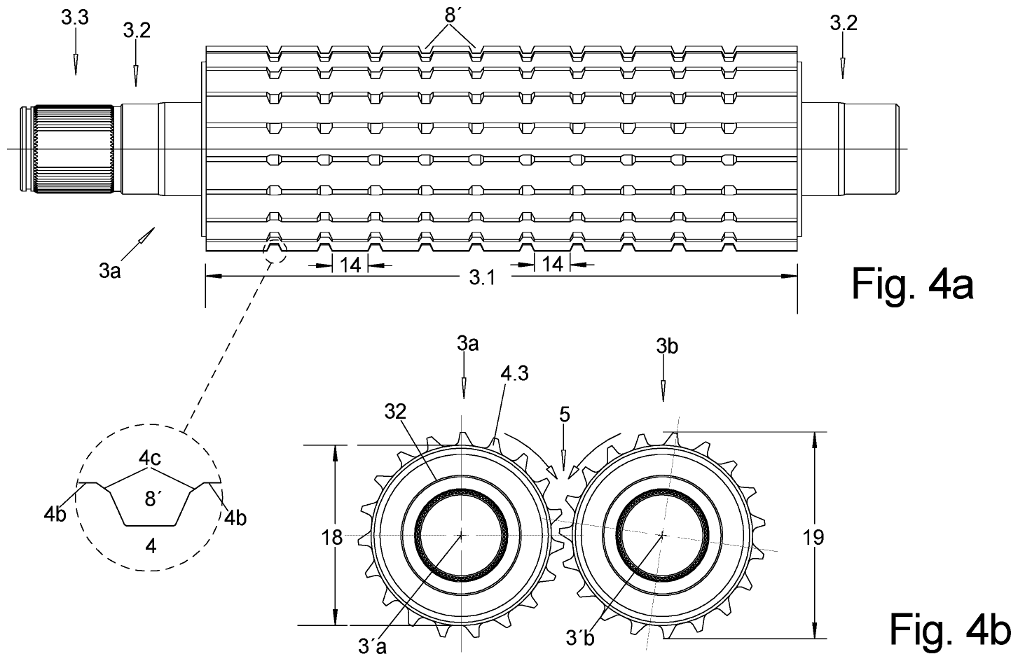

FIGS. 4a, b illustrate a crushing roller in a side view and in a face view.

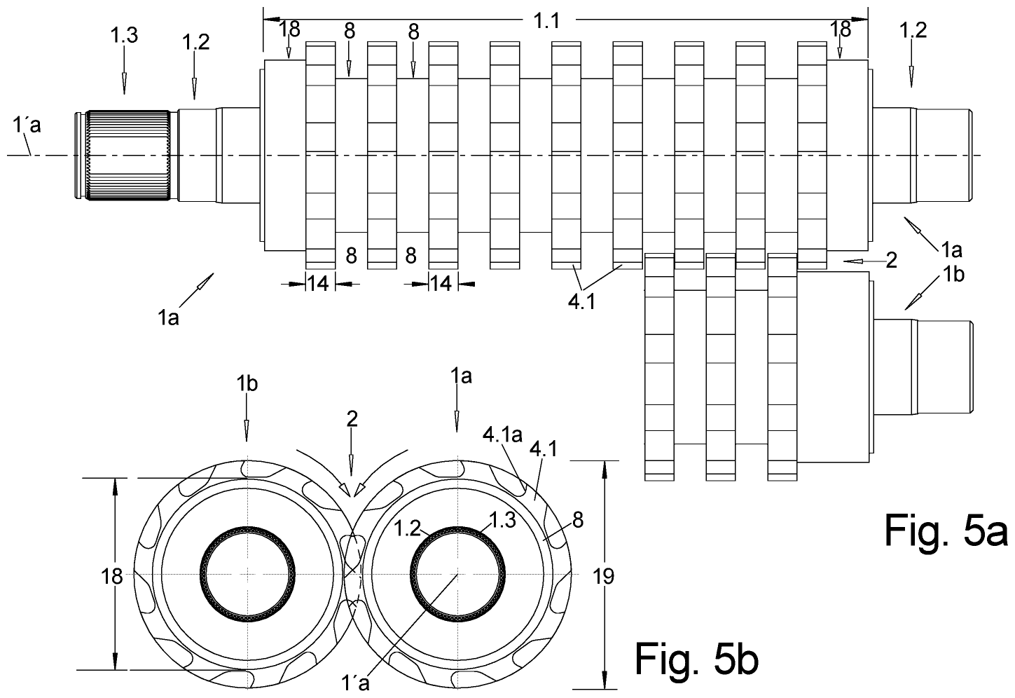

FIG. 5a, b illustrate a pressing roller in a side view and in a face view.

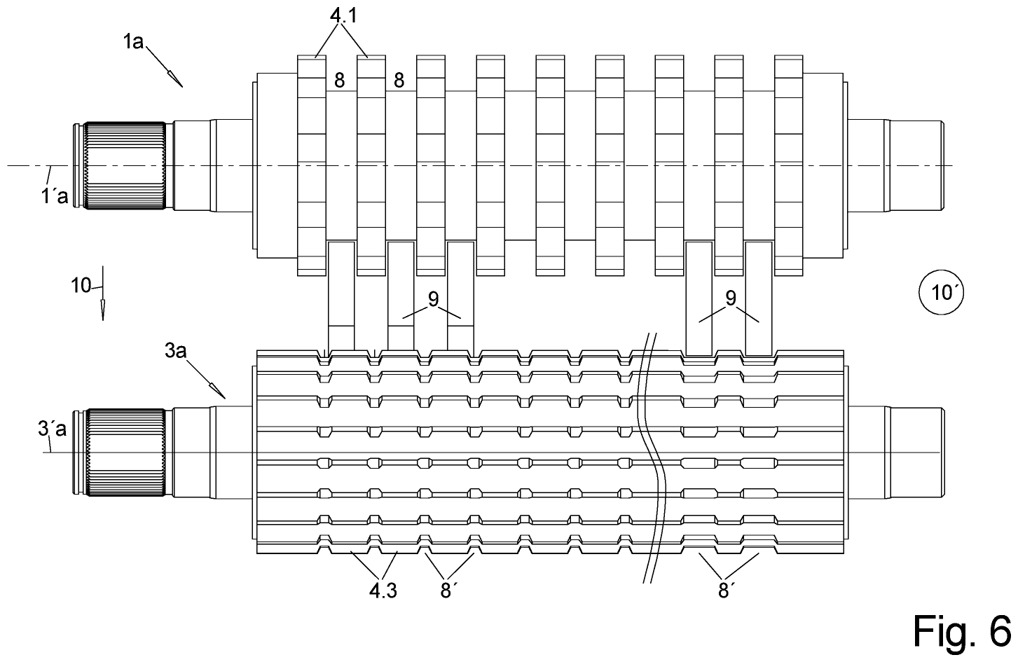

FIG. 6 illustrates a side view of a pressing roller and a crushing roller assembled in pass-through direction behind one another and with wipers there between;

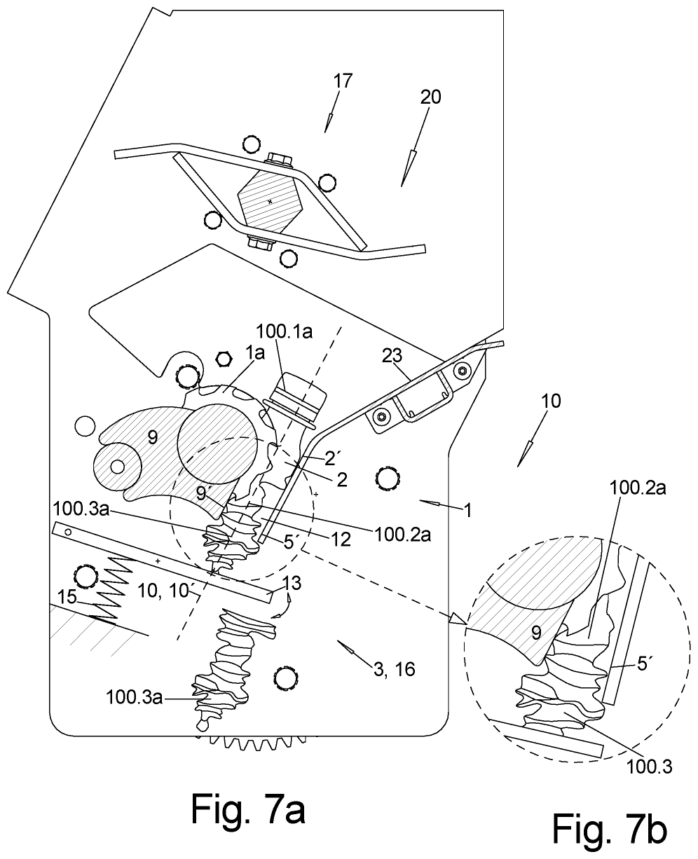

FIG. 7a illustrates a second embodiment of the compacting device cut perpendicular to the axes direction of the pressing roller included therein;

FIG. 7b illustrates a blown-up detail of FIG. 7a; and

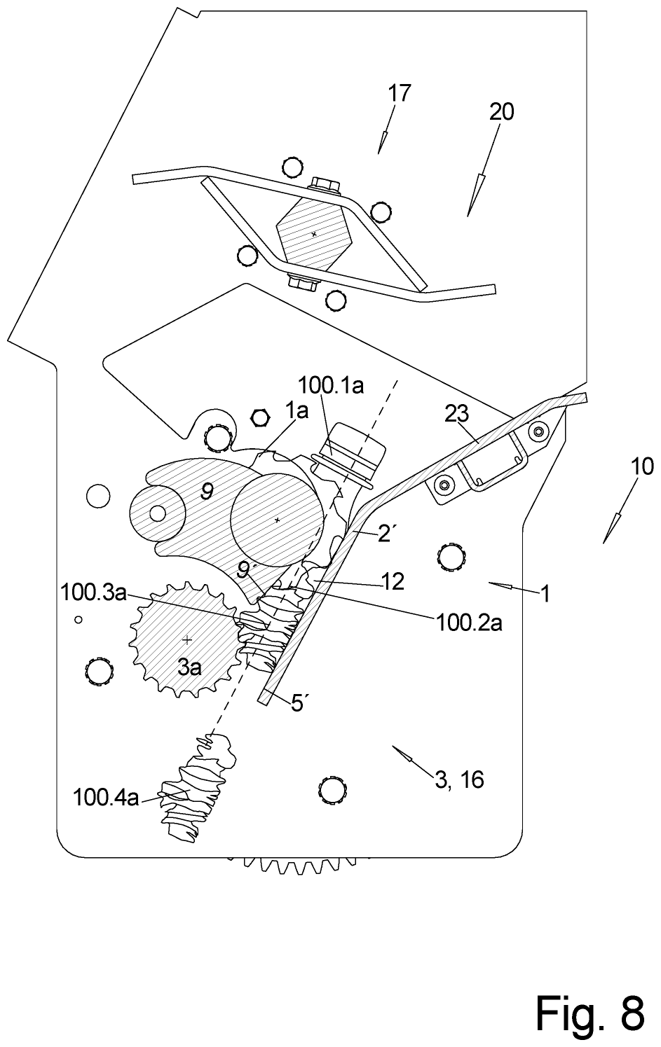

FIG. 8 illustrates a third embodiment of the compacting device cut orthogonal to an axis orientation of the pressing roller and crushing roller arranged therein.

The basic configuration of the crushing device can be described best with reference to FIG. 1a, b and FIG. 2.

As evident from FIG. 2a, b the compacting device comprises:
on the one hand side a pressing device 1 for compressing hollow elements, the pressing device including 2 pressing rollers 1a, b that rotate about parallel rotation axes 1′a, 1′b wherein the pressing rollers are arranged adjacent to each other rotate in opposite directions and engage one another;
and a crushing device 3 arranged in the flow-through direction 10 downstream of the pressing device 1 and including 2 crushing rollers 3a, b that are arranged adjacent to each other and rotate counter acting about parallel rotation axes 3′a, 3′b which either also mesh with each other or include a very small crushing slot 5 between each other.

The pressing rollers 1a, b are driven counter acting in a direction so that they move in the pass through direction 10 and an adjacent circumferential portion. The same applies for the 2 crushing rollers 3a, b.

The pressing slot 2, thus the passage between the 2 pressing rollers 1a, 1b and the crushing slot 5, thus the passage between the 2 crushing rollers 3a, 3b are advantageously aligned with each other in that the 2 roller pairs have an aligned central perpendicular to the connection line between their respective rotation axes 1′a, 1′b or 3′a, 3′b, wherein the connection line represents the pass-through direction 10 and is not oriented precisely vertical in this embodiment but slanted top down.

In FIG. 2a, b a respective plate-shaped wiper 9 is illustrated at each of the pressing rollers 1a, b wherein a main plane of the wiper is in the drawing plane of FIG. 2a, b wherein several wipers are arranged behind one another in the viewing direction 2 so that they engage the grooves 8 (c.f., FIG. 5a, b), in particular in all grooves 8 and wherein the wiper is retained in position between a respective pressing roller 1a, b and an opposite element in a form-locking manner transversal to the axial direction. The wipers 9 are illustrated, e.g., also in FIG. 3d1 and in FIG. 6.

A feed device 20 for feeding the hollow elements 100.1a, 100.1b is provided in the pass-through direction 10 upstream of the pressing device 1, wherein the feed device includes a blade sliding surface 23 that extends at a downward slant in a direction towards the pressing slot 2 and a blade shaft 17 that is arranged at a distance to the blade sliding surface 23 wherein a rotation axis 17′ of the blade shaft 17 is also oriented parallel to the rotation axes 1′a, 1′b, or 3′a, 3′b of the four rollers 1a, 1b or 3a, 3b, and wherein the blade shaft is drivable in a direction of rotation so that the blades 17a, 17b that protrude from the blade shaft 17 on both sides push hollow elements in pass-through direction wherein the hollow elements are disposed there between on a side that is oriented towards the blade sliding surface 23, thus the hollow elements are fed towards the two roller pairs of the pressing device 1 and the downstream crushing device 3.

As illustrated in FIG. 1a, b, all four rollers 1a, 1b, 3a, 3b, as well as the blade shaft 17 are received between two side lobes of a housing and supported at the side lobes and all four rollers are jointly driven by a drive device 6 that includes an electric motor 6a and an electric junction box 7, wherein the entire drive device 6 is mounted on a transversal plate that extends in a transversal direction to the two side lobes and is bolted together with both side lobes.

The drive device 6 drives all four rollers 1a, 1b, 3a, 3b as well as the blade shaft 17 through gears and chain drives, however, with the subsequently discussed angular velocities that differ from each other.

For this purpose the drive device 6 drives one of the two pressing rollers through a chain drive that is arranged closely outside of the side lobe wherein the drive device also drives the other pressing roller and the two crushing rollers 3a, 3b through sprockets that are attached thereon torque proof, while the blade shaft 17 is driven by the directly driven pressing roller 1b outside of the other lobe through another chain drive.

It is furthermore evident that an axis offset of the two pressing rollers 1a, 1b is identical in this case to the two crushing rollers 3a, 3b which, however, is not mandatory for the invention.

The pass-through distance 21 between the connection lines that extend parallel to one another between the two rotational axes of the pressing roller pair on the one hand side and of the crushing roller pair on the other hand side viewed in axis direction as illustrated in FIG. 2a is only slightly larger than an average of a diameter of a pressing roller and a diameter of a crushing roller.

It is appreciated that a “connection line” between the two rotation axes is recited for simplification reasons due to the two-dimensional illustration, wherein it is appreciated that this is a connection plane that is defined by the two rotation axes.

Advantageously the two pressing rollers 1a, 1b are configured as mirror images in the axial direction at least in their operating portion which is described later, and on the other hand side also the two crushing rollers 3a, 3b.

FIG. 2a, b differ in that the blade shaft 17 is respectively illustrated in another rotation position.

In FIG. 2b the blade shaft 17 is in a rotation position so that one of the blades 17a is in the position where its free blade edge 17a1 has the smallest possible blade distance 24a from the blade opposite surface 23 viewed in axial direction.

In FIG. 2b, however, the blade shaft 17 is illustrated in a position so that a free pass-through between the blade shaft 17 and the blade sliding surface 23 is maximized, thus the largest blade distance 24b is illustrated.

Depending on the smallest and largest blade distance 24a, b desired, the radius, thus the throwing circle of the freely terminating edge 17a1, 17b1 of the blades 17a, 17b, to the rotation axis 17′ has to be predetermined and an axis distance 22 between the rotation axis 17′, the blade shaft 17 and the blade sliding surface 23 has to be determined.

In this case there are only two blades 17a, b, which are provided at the blade shaft 17 and configured identical and mounted at the blade shaft 17 so that a radial distance of their free end edges to the rotation axis 17′ is identical.

FIGS. 3a-d illustrate the feed function, the pressing function and the crushing function of the hollow elements 100.1a, 100.1b, to be processed in a sectional view of the compacting device with a viewing direction in an axial direction of the rollers 1a, b, 3a, b and/or the blade shaft 17.

In FIG. 3a a deformed large hollow element 100.1a configured as a plastic bottle is arranged in the feed device 20 in which the non-deformed hollow element 100.1a contacts the blade sliding surface 23 and slides down on the blade sliding surface 23 in a direction of its greatest extension 100′ so that its lower end already contacts one of the two pressing rollers 1a, b.

As evident, a smallest extension 100″ of the hollow element 100.1a of the largest hollow element 100.1 to be processed is still smaller than a largest possible blade distance 24b between the blade shaft 17 and the blade sliding surface 23.

A front surface of the blade 17a that is oriented in rotation direction has a camber in a portion between the central element of the blade shaft 17 where it is bolted down and its free terminal edge 17a1 which can include a serration 25 as illustrated in FIG. 1b so that the free end portion is curved backward, thus swept back in rotation direction relative to the portion that is proximal to the central element. The blade 17a contacts a topside of the non-deformed container 100.1a in this portion with its front surface.

When the blade shaft 17 continues to rotate as illustrated in FIG. 3b, the blade 17a compresses the hollow element 100.1a in the transversal direction 11 of a direction of its largest extension 100′, in particular in the direction of its smallest extension 100″ and presses the hollow element 100.1a against the blade sliding surface 23 and additionally further in a direction of the pressing device 1, thus of the pressing roller pair 1a, b which grip a contacting end of the hollow element 100a with their teeth and pull the hollow element between each other, thus through the pressing slot 2 and thus deform it into an approximately plate-shaped hollow element 100.2a as illustrated in FIG. 3c.

Thus, the blade shaft 17 has a circumferential velocity that is higher than a circumferential velocity of the pressing rollers 1a, b.

Since typically there is no clear distance between the pressing rollers 1a, b in viewing direction of FIG. 3b, c but the teeth of the pressing roller 1a engage the teeth of the other pressing roller 1b, the approximately plate-shaped deformed hollow element 100.2a is wave-shaped on the one hand side in the pass-through direction 10 and on the other hand side also wave-shaped in the axial direction 1′a of the pressing rollers 1a, b as evident in the blown-up view of FIG. 3c1. Additionally the wall sections of the plate-shaped deformed hollow element 100.2a are partially cut by the teeth 4.1 which are closely adjacent in this plate-shaped condition but only through a defined cutting length, thus perforated.

Through additional pulling the plate-shaped hollow element 100.2a will protrude further and further from the pressing slot 2 of the pressing device 1 and will thus protrude into the crushing slot 5 between the two subsequent crushing rollers 3a, b and will be gripped by their teeth 4.3 as illustrated in FIG. 3d and in the blown-up view of FIG. 3d1.

Thus, the crushing slot 5 can be a distance between the outer circumferences of the crushing rollers 3a, b as illustrated in FIG. 3a in axial direction, thus for serrated crushing rollers a clear distance between the throwing circles of their teeth 4.3 or the outer circumferences or throwing circles can contact each other or almost contact each other with a distance which is significantly less than a distance of the crushed hollow element 100.3 as illustrated in FIGS. 2a, b, 3b through d. The throwing circles of the teeth 4.3 however can also overlap in the radial direction, so that the teeth 4.3 penetrate gaps between the teeth 4.3 of the adjacent crushing roller in the circumferential direction in an alternating manner.

Since the circumferential velocity of the crushing rollers 3a, b is significantly less than the circumferential velocity of the pressing rollers 1a, b the plate-shaped hollow element 100.2a that is pushed by the pressing rollers 100a, b out of the pressing slot 2 is crushed between the pressing roller pair 1a, b and the crushing roller pair 3a, b against the pass-through direction 10 and the already crushed hollow element 100.3a that is shorted by a large amount in this pass-through direction 10 is run through between the crushing rollers 3a, b and thus compressed again transversal to the pass-through plane 10′ which is arranged in a plane that extends in the pass-through direction 10 and parallel to the four rotation axes plural 1′a, 1′b, 3′a, 3′b to form a crushed hollow element 100.4a that is additionally compressed in the transversal direction 11.

As illustrated in particular in the blown-up view of FIG. 3d1, the narrow sides of the plate-shaped wiper 9 that are oriented towards each other, the wiper surfaces 9′ define a support slot 12 in the transversal direction 11 to the pass-through plane 10′ wherein the support slot defines the thickening of the flattened hollow element 100.2a in this portion.

Since the wipers 9 terminate in the pass-through direction 10 at a distance 26 in front of the crushing rollers 3a, b, an additional thickening of the hollow element 100.3a that is already being crushed is possible in this offset before the hollow element is captured by the crushing rollers 3a, b and is compressed again in the transversal direction 11.

In this sectional view of FIGS. 3c, 3d it is apparent that the end condition of the hollow element 100.4a, whose size decreases in the viewing direction of these figures over all three processing situations of FIG. 3b, c, d corresponds to a much reduced volume compared to the plate-shaped hollow element 100.2a that is compressed by the pressing device and whose length in pass-through direction corresponds essentially to the greatest extension 100′ of the hollow element 100.1a.

FIG. 3b also illustrates a smallest hollow element 100.1b configured as a beverage can that still has to be processed by the device in addition to the maximum size hollow element 100.1a that still has to be processed by the compacting device.

In order to optimize the crushing effect, it has to be assured that the hollow elements 100.1 that are to be processed are respectively pulled in a direction of its largest extension 100′ and which are run in the pass-through direction 10 through the device.

Therefore, a width of the axial operating portion 1.1 of the pressing rollers 1a, 1b is selected smaller than a longest extension 100′ of the smallest, in particular shortest, container 100.1b that is provided for processing and illustrated in FIG. 5a, so that also this container has to be fed to the device in a direction of its largest extension 100′.

It is furthermore evident in FIG. 3b that the smallest blade distance 24a illustrated in FIG. 2a is smaller than the smallest extension 100″ of the smallest container 100.1b that is to be processed so that the blade 17a still engages the container 100.1b also when this is the smallest container and moves the container along in a direction of the pressing device 1 and advantageously compresses the container in its transversal direction, thus in a direction of its smallest extension 100″. Namely this compression puts up the resistance against the rotating blade 17a, b that is sufficient for the feed effect.

The blades 17a, b can still have an increasing elasticity in their portion towards the free end.

In the instant embodiment this is achieved in spite of constant wall thickness of the plate-shaped blades 17a, b that protrude radially in the opposite direction from their attachment location at the central body in that the blades 17a, 17b are supported from their attachment location at the central element to their forward free end edge 17a1, 17b1 are support at their backsides approximately in the center portion and thus by the rear end edge 17a2 of a particular other blade 17a wherein advantageously there are only two blades 17a, b that are distributed over the circumference.

For this purpose the plate-shaped blades 17a, b that are elbowed in the viewing direction of the rotation axis 17 two times with their end portion into the same direction, wherein the blades are bolted with their center portion between the two elbows with the central element of the blade shaft 17, wherein the shape and size of the blades 17a, b is selected so that each blade 17a, b supports with its rear free end edge 17a2, 17b2 the back side of the forward portion of the other blade 17b, a between its bolted connection at the base element and its free forward end edge, advantageously at a back side of its forward elbow.

FIG. 7a with an enlarged detail in FIG. 7b illustrates a much simpler second embodiment of the compacting device.

Contrary to the first embodiment, the pressing device 1 is only made from a single pressing roller which pulls the hollow element 100.1a between the pressing roller 1a and a pressing support surface 2′ extending at a distance from its circumference through the pressing slot 2, wherein the pressing support surface 2′ is advantageously formed by the extension of the blade sliding surface 23 of the upstream feed device 20.

Also the crushing device 3 is configured much simpler.

The crushing device 3 includes a stop 13 configured as a plate which protrudes transversally into the movement path of the hollow element 100.2a that is pressed out of the pressing device 1 and flattened, and which crushes the hollow element 100.2a into a crushed hollow element 100.3a.

In order to take care of the material that is pushed out of the pressing slot 2 the plate-shaped stop 13 is pivotably supported by the pressing slot 2 remote from the pass-through direction and preloaded in a direction 1 by the spring 15. This crushing device 3 is also essentially a break device 16 for the flattened hollow element 100.2a that is pushed out of the pressing device 1.

Thus, the hollow element 100.2a is crushed against the pass through direction 10 but can also easily escape laterally and therefore a support slot 12 adjoins downstream of the pressing slot 2 which is formed on the one hand side by the wiper surfaces 9′ of the wipers 9 of the pressing roller 1a and on the other hand side by a crush support surface 5′ which includes the extension of the press support surface 2′ in the pass-through direction 10 beyond the portion of the pressing roller 1a.

In spite of that both terminate at a distance in front of the plate-shaped stop 13.

In particular, however, contrary to the first embodiment the crushed hollow element 100.3a is not compressed a second time in the transversal direction 11 to the pass-through direction 10 after the crushing.

Thus, a highly simplified device of this type will by far not achieve the same compacting result as the illustrated first embodiment of the device and will also not function without problems.

A medium solution between the first embodiments of FIGS. 2 and 3 and the second embodiment of FIG. 7a is the third embodiment according to FIG. 8.

Thus the pressing device 1 is configured the same as for the second embodiment according to FIG. 7a, b, however with the difference that the only provided pressing roller 1a reaches either directly to the press support surface 2′ or even into corresponding grooves in the component that extend in the pass-through direction, thus a plate whose outer surface represents the press support surface 2′ in order to cause a cutting of the wall of the hollow element 100.1a by the teeth 4.1 of the pressing roller 1a.

The crushing device 3 differs from the crushing device of FIG. 7a, b in that it has no plate-shaped stop but a rotating crushing roller 3a that is analogous to the crushing roller 3a of the first embodiment which is arranged in the pass-through direction after the pressing roller 1a and in a opposite crush support surface 5′ that is arranged at a distance, wherein the crushing slot is arranged between the pressing roller and the crush support surface.

The crush support surface 5′ is the extension of the press support surface 2′.

The embodiment of FIG. 8 thus can be viewed as a half left of the crushing slot 5 and the press slot 2 of the first embodiment according to FIGS. 2a, b, 3a through c, wherein the half right of it is replaced by the press support surface 2′ and the subsequent crush support surface 5′ which advantageously transition into each other without a shoulder.

Thus, this embodiment has the advantage that the crushed hollow body 100.3a is compressed again by this embodiment of the crushing device 3 transversal to the pass-through direction 10 in order to form a crushed and compressed hollow element 100.4a and is thus compacted further.

FIGS. 4a, b, 5a, b illustrate a pressing roller 1a and a crushing roller 3a respectively in a side view and in a face view, and in FIG. 6 in a mounted condition.

FIG. 5a illustrate in the side view, thus transversal to the rotation axis 1′a of the illustrated pressing roller 1a, the operating portion 1.1 in the center, in which the annular tooth portions 14 that are covered with teeth 4.1 in the circumferential direction alternate in the axial direction 1′a of the pressing roller 1a with ring grooves 8 whose groove base has a smaller diameter than a base diameter 18 of the pressing roller 1a, from which the teeth 4.1a protrude in an outward direction. Thus the grooves 8 are advantageously wider in the axial direction than the teeth 4.1.

Bearing journals 1.2 are visible that protrude axially from the operating portion 1.1 wherein the pressing roller 1a is supported in the two side lobes that are visible in or at FIG. 1a, b.

Additionally a protrusion adjoins at a face of the bearing journal 1.2 wherein the protrusion has a multi-tooth profile 1.3 on its circumference wherein the multi-tooth profile is used for sliding a sprocket onto the multi-tooth profile and fixating the sprocket to provide a chain drive of the pressing roller 1a.

As illustrated in the right portion of FIG. 5a, the second pressing roller 1b is arranged relative to the first pressing roller with respect to an arrangement of their tooth ring portions 14 and their grooves 8 so that their teeth 4.1 radially engage the grooves 8 of the first pressing roller 1a and vice versa, wherein the teeth 4.1 of one pressing roller 1b advantageously do not penetrate further than to the base diameter 18 between the tooth ring portions 14 of the other pressing roller 1b as evident from the face view of two meshing pressing rollers 1a and 1b of this type in FIG. 5b.

The base diameter 18 is provided and illustrated in FIG. 5 on a face side outside of the respective last tooth ring portion 14 that is illustrated in the axial direction.

In order to achieve good capture and ingestion of the hollow element 100.1a/b to be processed, the teeth 4.1 that are advantageously evenly distributed over the circumference respectively have a front flank that precedes with a free radially outer end which forms a hook-shaped front end portion of the tooth 4.1 which can engage and cut into the wall material of the container 100.1 with a sharp radially outer edge.

The incisions according to FIG. 5b in a direction of the rotation axis 1′a between the teeth 4.1a that are adjacent in the circumferential direction of a tooth ring portion 14 are approximately configured U-shaped wherein the transitions from their flanks to their bases are strongly cambered and the forward oriented front flank 4.1a of this recess is flatter than its rear edge, the front flank 4.1a of the next tooth 4.1.

These incisions are advantageously configured helical about the axial direction 1′a of the respective pressing roller 1a, b so that a hollow element is not simultaneously gripped by two axially offset teeth 4.1 but sequentially which reduces a loading of the pressing rollers 1a, b.

Thus the tooth height in radial direction corresponds
with respect to the base diameter 18 to half a difference between an entire diameter 19 to a pressing roller 1a and the base diameter 18, and/or
with respect to the groove base of the ring grooves 18 to half a difference between a diameter of the groove base and entire diameter 19 of the pressing roller 1a.

In FIG. 4a, b, however, a crushing roller 3a meshes in side view with two crushing rollers 3a, b, thus their cooperation is illustrated in a face view from which a difference of the configuration compared to a pressing roller 1a becomes clear.

The solutions have in common that a respective central bearing journal 3.2 extends on a face side into the axially extending operating portion 3.1 and additionally beyond the bearing pinion a protrusion on which a multi-tooth profile 3.3 is arranged.

From FIG. 4 it is initially evident that the inclination of the teeth that is visible in the axial direction which are arranged on the crushing roller 3a distributed over the circumference and distributed in the axial direction is oriented opposite to the direction of rotation, whereas the inclination of the teeth 4.1 is oriented in the direction of rotation in the pressing roller 1a, b.

This improves the intended crushing effect or braking effect for the plate-shaped hollow element 100.2 that arrives in the crushing slot 5.

Furthermore, it is evident that offsets 8′ between the individual teeth 4.3 that are provided in the crushing rollers 3a, b between the tooth ring portions 14 in axial direction do not reach radially down to a base of the tooth, thus a groove that extends in the axial direction 1′a between two circumferentially adjacent teeth 4.3 is continuous in the axial direction and no circumferentially extending groove is arranged in the groove base.

Furthermore, an extension of a tooth ring portion 14 is much greater in the axial direction than an axial extension of the offset 8′ between the axially offset teeth 4.3.

Accordingly, the two pressing rollers that rotate adjacent to each other about parallel axes 3′a, 3′b can only come into engagement with each other in that they are positioned in their alternating rotational position as evident from FIG. 4b so that the tooth 4.3 viewed in the crushing gap 5 in the axial direction of the one pressing roller 3a penetrates between two circumferentially adjacent teeth 4.3 of the adjacent crushing roller 3b but does not reach the base diameter of the other pressing roller 3b and vice versa.

The mutual distance in the radial direction as well as in the circumferential direction is required for absorbing the material of the container 100.2 that is run there between and already flattened contrary to the pressing rollers according to FIG. 5a, b where a clearance in axial direction between adjacent teeth 4.1 is not mandatory or shall even be avoided in order to cause the wall material of the container 100.2 to be cut through.

The other advantageous solution is to provide a clear pass-through as a crushing slot 5 between the throwing circles of the teeth 4.3 of the 2 crushing rollers 3a, b.

FIG. 6 illustrates the arrangement of a pressing roller 1a relative to the adjacent crushing roller 3a in a side view according to FIGS. 5a, 4a.

Thus, permanently mounted plate shaped wipers 9 are drawn which extend with their main plane orthogonal to the rotation direction 1′a and penetrate into each of the grooves 8 of the pressing roller 1a and reach as closely as possible to its bottom in order to remove possibly adhering material of the hollow elements from the pressing roller 1a during its rotation.

For the crushing roller 3a illustrated thereunder 2 different options are illustrated adjacent to each other.

In the left portion the offsets 8′ between the teeth 4.3 of this crushing roller 3a are smaller in the rotation direction 3′a, than the offsets between the teeth 4.1 of the pressing roller 1a and do not correlate in the axial direction with them either.

Accordingly the wipers 9 terminate before the outer circumference of the teeth 4.3 of the crushing roller 3a wherein the wipers continue in the viewing direction of FIG. 6 behind the crushing roller 3a in the direction of rotation 3′a.

In the right half however the grooves 8 of the pressing roller 1a are aligned with the offsets 8′ of the crushing roller 3a in the axial direction so that the wipers radially penetrate with their 2 end portions into the grooves 8, and on the other hand side into the offsets 8′ wherein the wipers are certainly offset from the pass through plane 10′ along which the flattened hollow element moves.

In particular the offset base of the offset 8′ having slanted flanks in a side view between the teeth 4.3 is wide enough in the axial direction so that the wipers 9 reach proximal to this offset base.

### REFERENCE NUMERALS AND DESIGNATIONS

1 pressing device
1a, 1b pressing roller
1′a, 1′b rotation axis
1.1 operating portion
1.2 bearing journal
1.3 multi-tooth profile
2 pressing slot
2′ press support surface
3 crushing device
3a, b crushing roller
3′a, 3′b rotation axis
3.1 operating portion
3.2 bearing journal
4, 4.1, 4.2 tooth
4a front flank
4b outer edge
4c camber, bevel
5 crushing slot
5′ crush support surface
6 drive device
6a motor
7 control
8 circumferential grooves
8′ offset
9 wipers
10 pass through direction
10′ pass through plane
11 transversal direction
12 support slot
13 stop
14 annular tooth portion
15 spring
16 break device
17 Blade shaft
17′ rotation axis
17a,b blade
17a1, 17b1 front free end edge
17a2, 17b2 rear free end edge
18 base diameter
19 total diameter
20 feed device
21 pass through offset
22 axes offset
23 opposite wing element, wing sliding surface
24a smallest blade distance
24b largest blade distance
25 teething
26 offset
100.1 non-deformed hollow element
100.2 flat end plate shaped hollow element
100.3 crushed hollow element
100.4 crushed and subsequently re-flattened hollow element
100′ largest extension
100″ smallest extension

1. A device for compacting hollow elements (100.1), including bottles made from plastic material or cans made from metal, the device comprising:
a) a pressing device (1) for flat pressing and optionally perforating a hollow element (100.1),
characterized in that
b) a crushing device (3) is arranged in pass through direction (10) downstream of the pressing device (1) for crushing the flattened plate shaped hollow element (100.2) in one of the directions of the main plane of the plate (100.2), in or against the pass through direction (10).

2. The device according to claim 1,
characterized in that
the device includes at least one drive device (6) for driving the pressing device (1) or the crushing device (3), and
a control for controlling the at least one drive device (6).

3. The device according to claim 1 characterized in that
the pressing device (1)
comprises at least one pressing roller (1a) that is drivable to rotate for capturing and pulling a hollow element (100.1) through a pressing slot (2) that is configured between the pressing roller (1a) and a pressing counter element (1b) in the pass through direction (10) which performs the flattening,
wherein the pressing counter element (1b),
either a particularly fixed pressing support surface (2′), or
a second rotatable, drivable pressing roller (1b) that rotates counter acting to the first pressing roller (1a).

4. The device according to claim 3, characterized in that
the pressing slot (2) has the constant width in the pass through direction (10) in that the widest spot is at the most 20% wider than the narrowest spot, or
the rotation axes (1′a, 1′b) of the pressing rollers (1a, b) are arranged parallel to each other.

5. The device according to claim 1 characterized in that
the crushing device (3),
comprises at least one crushing roller (3a) that is drivable to rotate for capturing and pulling a flattened hollow element (100.2) through a crushing slot (5) that is formed between the crushing roller (3a) and an opposite crushing element (3b) in the pass-through direction (10),
wherein the opposite crushing element (3b),
comprises either a fixed crush support surface (5′),
or a second rotatable crushing roller (3b) that is drivable counter rotating to the first crushing roller (3a).

6. The device according to claim 5, characterized in that
the crushing slot (5) is arranged in the pass-through direction (10) or positioned so that a flattened hollow element (100.2) that is moved through between the pressing rollers (1a, b) in the pass-through direction reaches into the crushing slot (5) as a matter of principle and is captured by the at least one rotating crushing roller (3a),
at least one drive device (6) is provided that is configured to drive at least one crushing roller (3a), with a lower circumferential velocity than the circumferential velocity of the two pressing rollers (1a, b).

7. The device according to claim 5, characterized in that the rotation axis (3a) of the first crushing roller (3a), also the rotation axis (3′b) of the second crushing roller (3b) is either approximately parallel to or oriented at an angle, in particular at a right angle, to the rotation axes (1′a, 1′b) of the pressing rollers (1a, b).

8. The device according to claim 5, characterized in that
the rollers (1a, b, 3a, b) have an operating portion (1.1, 3.1) in a direction of their rotation axes (1′a, 1′b, 3*a, 3*b) in a center portion and bearing journals (1.2, 3.2) that protrude axially on a face side beyond the operating portion wherein the operating portion (1.1, 3.1) is shorter in its axial direction than a largest extension (100′) of the smallest hollow element (100.1b) that is provided for processing.

9. The device according to claim 5, characterized in that,
the at least one pressing roller (1a, b) or the at least one crushing roller (3a, b) include teeth (4) that are arranged in the operating portion (1.1, 3.1) distributed over the circumference in a radial direction beyond the base diameter (19) of the roller in the operating portion (1.1, 3.1), and
the pressing rollers (1a, b) include teeth (4) within plural axially offset tooth ring portions (14), and
the teeth (4) of the first pressing roller (1a) penetrate in the radial direction into the axial offsets between the tooth ring portion (14) of the adjacent pressing roller (1b).

10. The device according to claim 1, characterized in that
a pass-through distance (9) between the pressing device (1) and the crushing device (3) between the respective tightest spot of the pressing slot (2), between the respectively tightest spot of the pressing slot (2) and of the crushing slot (5),
is shorter than a length (100′) measured in the pass-through direction (10) of the shortest flattened hollow element (100.2b) intended for processing, shorter than a greatest longitudinal extension (100′) of the shortest non-deformed hollow element (100.1b), or
at least large enough so that the crushing when processing the longest hollow element (100) in the pass-through direction (10) is not strong enough yet so that stress whitening occurs at bending spots of the crushed hollow element (100.3a) if it is made from a synthetic material, at more than 10% of the bending locations.

11. The device according to claim 1, characterized in that
teeth (4.1) of the at least one pressing roller (1a, b) viewed in their axial direction (1′a, 1′b) have a front flank (4.1a) oriented in the direction of rotation wherein the front flank is oriented radially to the axial direction (1′a, 1′b) or their free outer end is arranged further forward relative to the inner end in the direction of rotation.

12. The device according to claim 1, characterized in that
teeth (4.3) of the at least one crushing roller (3a, b) include a curvature or a bevel (4c) viewed in the circumferential direction at a transition from their outer edges (4b) to their side flanks, or
provided circumferential grooves (8) have a curvature or a bevel (4c) between the tooth ring portions (14.1, 14.3) viewed in the circumferential direction at a transition from their groove base to their lateral groove flanks.

13. The device according to claim 1, characterized in that
teeth (4.1) of the at least one pressing roller (1a), as a function of a wall thickness of hollow elements (100.1) provided for processing are sized and positioned relative to their other pressing roller (1b) so that at least one wall of the hollow element (100.2), at least both walls are penetrated by the teeth (4.1), cut through when the hollow elements run through the pressing device (1).

14. The device according to claim 1, characterized in that
wipers (9) reach into the axial offsets, the circumferential grooves (8) between the tooth-ring portions (14) with their wiper surface (9′) approximately tangentially to a circumference of the base element of the roller and against the pass-through direction (10),
the wipers (9) of the at least one pressing roller (1a) reach as closely as possible to the crushing device (3), the circumference of the at least one crushing roller (3a), into the axial offsets between the tooth-ring portions (14) of the at least one crushing roller (3a).

15. The device according to claim 1, characterized in that
a support slot (12) that is defined by the wiper surfaces (9′) of the axially offset wipers (9) and possibly an opposite crush support surface (5′) expands in the pass-through direction (10) viewed in the axial direction.

16. The device according to claim 1, characterized in that
a blade shaft (17) that is drivable to rotate has a rotation axis (17′) approximately parallel to the pressing slot (2), is arranged upstream of the pressing device (1) and opposite to a blade counter-element (23), a feed sliding surface (18), wherein a blade (17a, b) is curved backward with its free end in the rotation direction or configured as a backward curved polygon section viewed in a direction of the rotation axis (17′).

17. The device according to claim 1, characterized in that
a blade shaft (17) is arranged at an axis offset (22) from the pressing slot (2) and relative to the blade counter-element (23) so that the blades (17a, b) press a hollow element (100.1) that sits on the blade opposite element (18) in a direction towards the pressing slot (2) when the blade shaft (17) is driven into the corresponding direction of rotation.

18. The device according to claim 1, characterized in that
a minimum blade distance (24a) between a free end of a blade (17a, b) and the blade counter-element (23) is smaller than a smallest extension (100″) of a thinnest and/or smallest hollow element (100.1b) provided for processing, or
the largest possible blade distance (24a) between the blade shaft (17) and the opposite blade element (23) is greater than the greatest extension (100′) of the thickest and/or greatest hollow element (100.1a) that is provided for the processing.

19. The device according to claim 1, characterized in that
the blades (17a, b) extend in an axial direction of the blade shaft 17 over at least 60% of a length of the operating portion (1.1) of the at least one pressing roller (1a), or
the free trailing edge of the blades (17a, b) includes a serration (25), or
the blades (17a, b) have a decreasing bending stiffness towards their free end transversal to their main plane, and
each blade (17a, b) viewed in axial direction is supported in its radial extension in its center portion in an opposite direction to the direction or rotation, thus on its backside, by the rear free end of another blade (17b, a) that contacts its backside.

20. The device according to claim 1, characterized in that
the crushing device (3) includes a stop (13) that is arranged transverse to the pass-through direction (10) in a movement path of the flattened, plate-shaped hollow element (100.2).

21. The device according to claim 20,
characterized in that
the stop (13)
is movable transverse to the pass-through direction (10) out of the movement path of the flattened, plate-shaped hollow element (100.2), movable in a controlled manner,
the stop (13) is force loaded against the pass-through direction by a spring (15) or a brake device (16), or
the stop (13) is configured movable in the pass-through direction (10), movable in a controlled manner.

22. A method for compacting hollow elements, in particular bottles made from synthetic material or cans made from metal, the method comprising the steps:
flattening a hollow element (100.1), transverse to its largest extension 100.1′,
characterized in that
the flattened, approximately plate-shaped hollow element (100.2) is crushed in one of the directions of the main plane of the plate (100.2), in a direction of the greatest longitudinal direction (100.2′) of the flattened hollow element (100.2).

23. The method according to claim 22,
characterized in that
crushing the flattened hollow element (100.2) is at least commenced before flattening the hollow element (100.1) is completed, or
crushing the flattened hollow element (100.2) is terminated the latest when the flattening of the hollow element (100) is completed.

24. The method according to claim 22,
characterized in that
flattening the non-deformed hollow element (100.1) is performed by pulling the non-deformed hollow element (100.1) through the pressing slot between at least one pressing roller (1a) that is driven to rotate and the press counter-element (1b), a counter-rotating second pressing roller (1b), or
the crushing is performed by braking the front end of the flattened hollow element (100.2) in the pass-through direction (10) compared to its pass-through velocity through the pressing slot (2),
by pulling the flattened hollow element (100.2) through a crushing slot (5) downstream of the pressing slot (2), in particular without slippage.

25. The method according to claim 22,
characterized in that
the hollow elements (100.1) to be processed are fed to the pressing slot (2) in a direction of their greatest longitudinal extension (100′).

26. The method according to claim 22,
characterized in that
the flattened plate shaped hollow elements (100.2) are fed to the crushing slot (5) in one of the directions of the main plane of the plate (100.2), in a direction of a greatest longitudinal extension (100′) of the hollow element (100) in a starting condition.

27. The method according to claim 22,
characterized in that
the device is operated so that a pass-through velocity through the crushing slot (5) is less than half of the pass-through velocity through the pressing slot (2), and
the circumferential speed of the at least one crushing roller (3a) during operations of the device is less than half of a circumferential velocity of the at least one pressing roller (1a).

28. The method according to claim 22,
characterized in that
the hollow element (100.1) is conveyed before flattening, conveyed by the blades (17a, b) of a blade shaft (17), and
the device is controlled so that a circumferential speed of the blades (17a, b) of the blade shaft (17) during operations has at least twice the size as the pass-through velocity through the pressing slot (2), as the circumferential speed of the at least one pressing roller (1a).
